(19) United States
(12) Patent Application Publication
(10) Pub. No.: US 2006/0036603 A1
(43) Pub. Date: Feb. 16, 2006

(54) Apparatus, system, and methods for collaborative research

(76) Inventor: Doug Laney, La Costa, CA (US)

Correspondence Address: NATH & ASSOCIATES, 112 South West Street, Alexandria, VA, 22314, US

(21) Appl. No.: 11/196,488

(22) Filed: Aug. 4, 2005

Related U.S. Application Data
(60) Provisional application No. 60/600,438, filed on Aug. 11, 2004.

(51) Int. Cl. G06F 17/30

(52) U.S. Cl. 707/9

(57) ABSTRACT

A collaborative research system, apparatus, and methods for collecting and evaluating market research data. Information Technology (IT) professionals submit evaluations to a database regarding their experiences with IT products and services. In return, their organizations receive periodic IT portfolio scorecards that inventory and benchmark their selected solutions against other organizations. Enlisted experts submit written market research reports to the evaluation database. In return, they receive limited access to the knowledgebase, consultation fees and a promotional channel. Vendors and businesses pay for access to the evaluation database, data analysis, market analysis, and consultations.

This application claims benefit of U.S. Provisional Patent Application 60/600,438 filed Aug. 11, 2004, the contents of which are hereby incorporated by reference in its entirety

### FIELD OF THE INVENTION

The present invention relates to a knowledgebase of evaluations, data and market analyses, and more specifically to an apparatus, system, and methods for providing access to collaborative research data.

### BACKGROUND OF THE INVENTION

Information technology (IT) vendors, buyers and implementers increasingly crave current, detailed, unbiased market intelligence to design, promote, select and deploy solutions swiftly and successfully.

The Internet enables technology buyers and producers to research issues themselves. It takes an order of magnitude less time today to compare and contrast vendor capabilities than ten years ago. Again, the Internet is an ideal medium for making research available, but in its current form of scattered, unstructured, and inconsistent content, the research is difficult to aggregate or analyze.

Key sources of technology research on the Internet include:

1. Vendor Websites that list their products and marketed capabilities, but offer no comparative analysis or insight.

2. Newsgroups, mail lists and message boards that post endless streams of occasionally useful technology-specific tidbits. These sources are very difficult to mine and provide little comparative analysis (and even less insight).

3. Online journals that offer technology reviews, some comparisons, but too are disorganized and difficult to mine.

To compete in a progressively crowded IT market place, vendors incessantly struggle to improve their offerings in-step with actual user needs while formulating marketing strategies based on spotty competitive intelligence. Similarly, IT departments struggle to meet business needs more efficiently and effectively by making better, faster IT investment decisions based on scattered comparative information. And, after selecting IT solutions, users seek best-practices advice on how to make their selected technologies integrate and perform well—thereby maximizing return-on-investment.

The worldwide IT market has grown ten-fold since 1985 to $2 trillion dollars, yet there is no market information service provider for the IT industry.

Corporations and government organizations adopt from 200 to 500 distinct IT solutions ranging from software to hardware to consulting services. Each solution is integrated with several others, upgraded annually, and considered for replacement approximately every three years. This leaves an IT department with thousands of complex technology-related selection and implementation decisions throughout the year. On the other side of the equation, each IT vendor's solution competes with up to 100 others. The pace of IT innovation and emergent solutions is far greater than in most other industries. This renders vendors, IT departments and consultants starving for timely, relevant competitive intelligence to ensure their success and often their survival.

The combinatorics and challenges of IT solution selection, implementation, development, and marketing are staggering and escalating. As a result, the demand for IT research and advisory services has grown 300% over the past three years. In 2001, the market was estimated at $15 B, of which IT analyst firms reaped $3 B, with the $12 M balance spent on costly custom research. About 15,000 enterprises spend $100,000 on average annually for IT research from one or more source. Financial analysts estimate the IT research market to grow at a pace 20% greater than the S&P 500 through 2006.

The Information Technology Market Research & Analysis industry (also known as “syndicated research,” “IT research,” “IT advisory services”) provides an indispensable resource for both builders and buyers of information technology. By generating analysis and insight into specific information technology markets, IT market research organizations (commonly known as “analyst firms”) help their retained clients select and deploy technology more quickly and with reduced risk. Similarly, through market and competitive analysis, they help vendors design better products, identify market opportunities, develop marketing strategies, identify potential partners, and optimize marketing programs.

Overall strengths of analyst firms are their primary focus on IT research, analysis, and advisory services. Many enterprises and vendors consider them an indispensable source of guidance in making technology-related investment decisions.

Overall weaknesses of analyst firms include their inability to continually capture, integrate and transform IT professional field experience into in-depth, broad-spectrum research content. Knowledge delivery is not their problem, but knowledge supply is. Also, it is well documented how their commercial relationships with vendors bias their research.

Enterprises purchase multiple subscriptions to the research service offered by these analysis firms because they derive different value from each, and seek to triangulate advice. Some analyst firms concentrate on generating market trend reports, some on making market predictions, some on delving deep into particular technology markets, and others on more intimate advisory services. Vendors are effectively compelled to subscribe to all major analyst firms that cover them. Only this way can they find out (and presumably influence) what is being written and said about them versus their competition, and with which other vendors they should form strategic relationships. Systems integrators leverage analyst firms to ensure they are up to speed on technology trends, to better organize their practices, to select technology partners, and to offer their clients best-practices implementation advice.

These annual subscriptions give retainer clients various levels of access to IT market research reports. A few of the larger analyst firms offer clients telephone consultations and limited on-site consulting with their industry analysts. Still, all analyst firms base their research entirely upon anecdotal recounts of client experiences with technology, vendor marketing, industry journal articles, and occasional client surveys.

In strong economic times, enterprises lean on analyst firms to make technology-related decisions more quickly and confidently, enabling them to implement better business solutions ahead of their competition. In a weak economy, enterprises may regulate the number of subscriptions they carry, but rely heavily on their analyst firms to advise on cost-cutting and efficiency-related alternatives.

Ironically, the energies spent by analyst firms chasing technology trends and competing head-on with one another have prevented them from evolving nearly as much as the enterprises they counsel. Instead most analyst firms remain biased by their vendor relationships, cannot continuously collect and analyze hard data points, and introduce a long lag time from data collection to availability. Even worse, they slog under a business model that introduces high labor expenses for on-staff analysts whose industry skills and expertise wane over time—thereby sacrificing both the firm's profitability and credibility.

As the base of technology expanded rapidly over the past few years, many opportunistic analysts and consultants have set out on their own, yielding a bevy of boutique analyst firms specializing in niche IT research (for example, customer relationship management, e-business, telecom, retail, manufacturing). This has put pressure on broad-spectrum analyst firms to sell and deliver into those particular markets. Particularly with typical research engines incapable of gathering in-depth analysis about a broad array of markets, boutique analyst firms have been able to convert targeted clients.

Although the IT market research field is dominated by a few companies, 90% of IT departments and vendors have said that they crave much richer data about the actual experiences of real IT professionals—not merely the musings of research analysts. And over 80% of IT executives voice concern about a lack of objectivity among IT analysts.

Therefore, what is needed is a unique process of collaboration with IT departments and market experts, to amass the deepest, broadest, most timely and most credible set of empirical IT research data and analysis. Such an information service will thereby become an indispensable, industry-standard resource for software publishers & hardware makers, resellers, consultants, and enterprises of all variety.

### SUMMARY OF THE INVENTION

The foregoing problems and shortcomings of the prior art are addressed and further advantageous solutions are provided by the present invention.

Therefore, it is an object of the present invention to provide access to a knowledgebase of evaluations, data and market analyses from actual technology users to supply IT vendors with the needed competitive intelligence to design better solutions and market them optimally.

It is a further object of the present invention to provide a knowledgebase that is continually fed with user evaluations, robust data analyses, and insightful market analyses—all available anytime to subscribing clients.

In accordance with another object of the present invention a method of continuous, rather than point-in-time surveying of Information Technology (IT) professionals is performed. The surveys concern questions regarding their experiences with IT products and services. The process introduces a standardized survey vehicle for any/all types of enterprise IT products or services. It enables the cross-product analysis of ranking and other quantitative data.

In accordance with another object of the present invention a method of continuously ranking IT solutions is provided which is based on purely empirical data (from actual users). The process includes a “diminishing weighting” algorithm that reduces the impact of a rating on the overall score as the evaluation becomes older (or ages). That is, more current evaluations contribute more heavily to the current ratings for a product or service. Furthermore, survey data collected is immediately available via updated ratings.

In accordance with another object of the present invention a method of providing self-service online query and alerts of changing research data is disclosed. Users may indicate the parameters of a query to generate online charts of aggregate survey data. Users may select to save the parameters for these queries to enable them to be re-executed periodically (for example, daily, weekly, monthly, quarterly) and have the resulting chart and/or a link to it emailed to the user or sent to the user via another electronic device. Users may also elect to have the chart/link sent to them whenever the underlying data for this query changes.

In accordance with a further object of the present invention a method of generating an IT portfolio scorecard is provided. Users may generate a scorecard for any or all IT products/services and vendors for which they have submitted an evaluation (survey). Scorecards contrast key indicators or metrics, for example, value, satisfaction, performance, functionality, compatibility, scalability, and cost, against averages for that product/service/vendor overall, and versus enterprises (in aggregate) of similar industry, geography, size, and revenues. Scorecards also indicate top performing alternate solutions for each indicator. IT departments can receive periodic assessments, including scorecards, of their “IT portfolio” in exchange for their staff completing the evaluations. The assessments show how-each of their selected IT solutions compares to similar solutions and similar organizations.

In accordance with a further object of the present invention a method of collaborating with IT industry experts is provided. The purpose is to solicit their written analyses in return for access to research data and the opportunity to get paid for and generate leads from user-requested consultations. Knowledgeable, experienced, and respected, individuals (primarily from the IT consulting community) are solicited and selected to write standardized analyses of the markets in which they are experts. In return for authoring a market analysis report, they will receive subscriber-level access limited to research, and be on-call when subscribers (paying users) request a consultation. They will get paid for completing the consultation and submitting discussion notes for the consultation. Such independent domain experts (IT “gurus”) can treat the consultations as qualified leads to promote their own related service offerings or otherwise further their own endeavors.

In accordance with a further object of the present invention a method of enabling users access to privatized survey forms completed by other users is provided. Actual surveys completed by users are made available for viewing by paying users (subscribers). Information that might allow a user to ascertain the identity of the individual or his/her employer is concealed from viewing.

In accordance with another object of the present invention a system is provided which represents the collective methods and technologies as a single business process referred to as the overall Collaborative Research Engine™.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is a flow diagram showing the typical users that access the data and reports in the knowledge base according to an embodiment of the present invention;

FIG. 1B is a flow diagram showing a Website storyboard according to an embodiment of the present invention;

FIG. 2A is a Website flow diagram showing the entire system interface according to an embodiment of the present invention;

FIG. 2B illustrates an example of the Home Page of FIG. 2A according to an embodiment of the present invention;

FIG. 3A illustrates an exemplary account that includes a list of a particular user's public evaluations according to an embodiment of the present invention;

FIG. 3B illustrates an exemplary first page of a survey according to an embodiment of the present invention;

FIG. 3C illustrates an exemplary form for a survey according to an embodiment of the present invention;

FIG. 3D illustrates another exemplary form for a survey according to an embodiment of the present invention;

FIG. 3E illustrates another exemplary form for a survey according to an embodiment of the present invention;

FIG. 4A illustrates aii exemplary vendor/product rating chart according to an embodiment of the present invention;

FIG. 4B illustrates an exemplary research update alert sent to a user via e-mail according to an embodiment of the present invention;

FIG. 5 illustrates an exemplary application of a diminishing algorithm of sample data according to an embodiment of the present invention;

FIG. 6 illustrates an exemplary IT portfolio scorecard according to an embodiment of the present invention;

FIG. 7A illustrates an exemplary page that provides a written analysis of a particular market according to an embodiment of the present invention;

FIG. 7B illustrates an exemplary page providing results for a queried market analysis intelligence report according to an embodiment of the present invention; and

FIG. 8 illustrates an exemplary Consultation/Analysis Request page according to an embodiment of the present invention.

### DETAILED DESCRIPTION OF THE PRESENTLY PREFERRED EXEMPLARY EMBODIMENTS

In overview form, the present disclosure concerns an apparatus, system, and methods that provide access and research services to users of a knowledgebase apparatus and system and specifically methods for implementing a tool for researching evaluations, data and market analyses. More particularly, various inventive concepts and principles embodied in an apparatus, system, and methods therein for providing and facilitating continuous access to market data are discussed and described to help users select hardware solutions, software solutions, and systems for their organization to keep pace with the rapid technological changes. Users have subscription-based access to data and analysis about solution selection, implementation and usage (initially focused on the IT industry).

The centerpiece of the system is a collaborative research engine that fuses independent, unbiased experiential evaluations from field analysts (evaluators) with exclusive and original content from the company's own enlisted third-party market analysts experts. Thus, subscribers can choose from a suite of static and dynamically populated self-service queries, alerts, scorecards along with accessible reports and event-triggered services, written analyses, and access to market experts and field analysts.

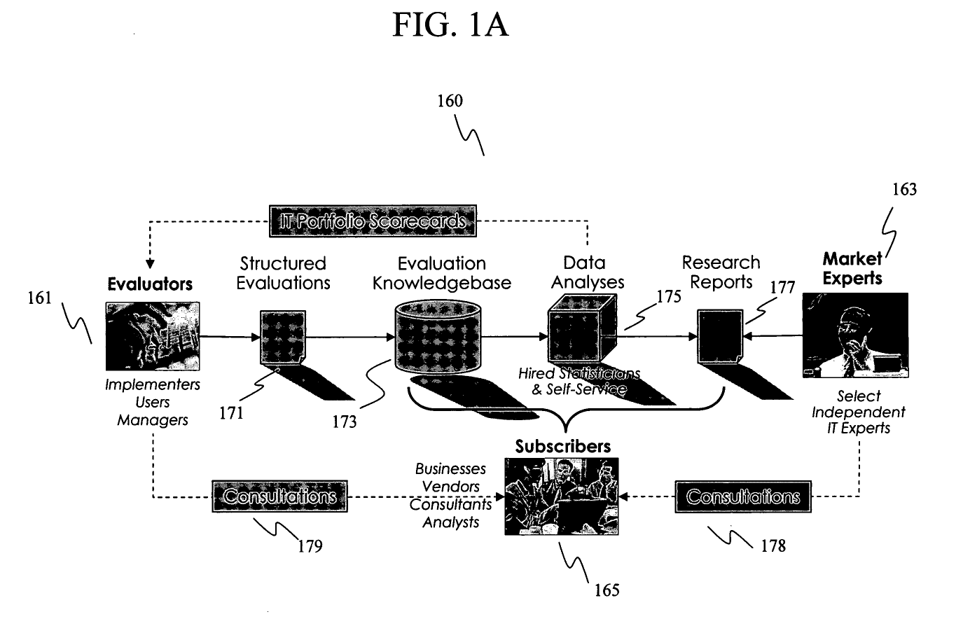

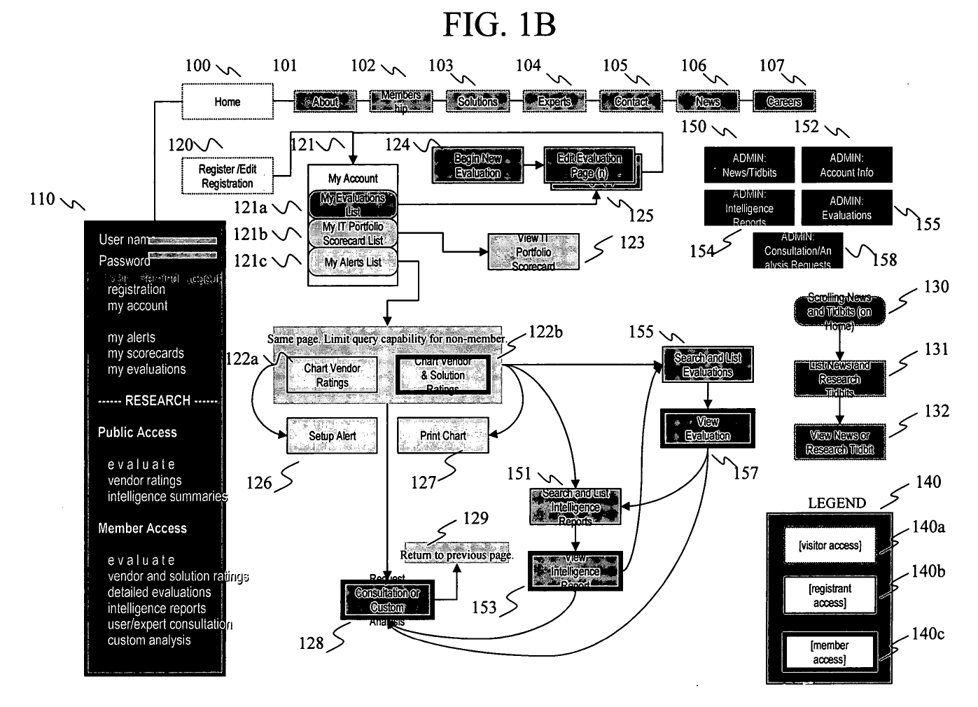

As shown in the flow diagram of FIG. 1A, the typical users that access the knowledge base may include:

1. Subscribers (Vendors) 165—Receive access to all detailed research, including evaluation knowledge base (EKB) 173, written market analyses research reports 177, detailed self-service online data analyses 175, and analyst consultations 178 and 179. Subscribers register information about their organization and themselves. Subscribers 165 contact the system to request consultations with field analysts 161 or market analysts 163.

2. Evaluators (Field Analysts) 161—Anyone submitting an online structured evaluation 171 to the evaluation knowledge base 173 can receive access to individual IT Portfolio Scorecards™ 180. These IT solution evaluations are about solutions they have experience with (for example, hardware, software, consultants, standards, education) and are used for data and market research and analysis to aid in IT investment decision-making. The analysts include information about themselves, their business, and their manager. Evaluations include various ratings (for example, satisfaction, value, difficulty), and descriptions (for example, project, selection process, implementation process). They indicate whether they wish to be contacted for telephone consulting opportunities to provide consultations 179 to subscribers 165.

3. Market Analysts Experts 163—Qualified consultants or IT professionals unaffiliated with vendors are offered subscriber privileges in return for writing short market analyses (research reports) 177 about what is happening in their field of expertise. These reports leverage and mention the data in the knowledge base. Market analysts receive personal access to the Evaluation Knowledge Base 173 and data analysis for the market they cover. They also provide consultations 178 to subscribers 165.

Statisticians (data analysts) create and update reports and indices against the quantitative evaluation data.

The knowledge base product fills a gap in the current market for IT vendor and solution analysis in which there is a distinct lack of empirical data collected from unbiased sources who are not themselves connected to the industry technology users. By democratizing the data gathering process with a unique collaborative and continuously updated methodology, this knowledge base is distinguished from other IT research enterprises by delivering uniquely unbiased research in real time, and online. Thus, the database has an agility that will allow the system to stay well ahead of existing forms of research whose lag-time is often measured in months.

The collaborative research engine of the present invention can be instantly adapted to any market in which there is an opportunity to introduce an empirical, online method for collecting and then availing this data back to the purveyors, consumers and other interested parties in the market place.

Unlike conventional IT analyst firms that collect erratic market data, dispense anecdotal analysis, and lack credibility due to their vendor relationships, the system that is of particular interest is one that may provide or facilitate the collection of continuous evaluations, data and market analyses. Furthermore, a system of interest and the like can maintain a stream of evaluations collected from actual technology buyers, implementers and users to provide IT vendors with the needed competitive intelligence to design better solutions and market them optimally. Likewise, IT departments and consulting organizations can leverage the system to help select and implement IT solutions with greater confidence, success and speed.

As further discussed below, various inventive principles and combinations thereof are advantageously employed to amass the deepest, broadest, timeliest and most credible set of IT research data and analysis. Note that this general rule will have various exceptions such as when original or updated data has not been provided and others that will be further explained and developed below. In this manner, information technology (IT) vendors, buyers and users can have access to an indispensable source of experiential intelligence to help them design, promote, select and implement technology solutions successfully provided the principles or equivalents thereof as discussed below are utilized.

The instant disclosure provides further explanation in an enabling fashion the best modes of making and using various embodiments in accordance with the present invention. The disclosure further offers to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, left and right, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

FIG. 1B is a flow diagram showing a Website storyboard according to an embodiment of the present invention.

Legend 140 located in the bottom right corner of FIG. 1B explains three types of access privileges, i.e. visitor access 140A (dotted boxes), registrant access 140B (solid boxes), and member access 140C (bold boxes). All links will not be discussed.

A visitor, a non-subscribing user who has not completed the registration process, has access to links on the Website such as the Home Page 100, the about link 101 which may describe the mission, philosophy, and methodology of the system, the membership link 102, the contact link 105, the news link 106, the registration link 120, and the careers section 107.

A registrant, a non-subscribing user who has completed the registration process, has access to certain links on the Website including links at the visitor access level and links such as the my account link 121 which may allow viewing of submitted evaluations, generated scorecards, and alerts, charting vendor rating 122A, beginning a new evaluation 124 or editing an evaluation 125, searching and listing intelligence reports 151, and searching and listing evaluations 155.

A member has access to certain links on the Website including links at the registrant access level and links such as charting vendor and solution rating 122B, requesting a consultation or custom analysis 128, and viewing intelligence reports 153 and viewing evaluations 157.

From the Home Page 100, a user may also use navigable submenu 110 to access other links on the site which will be discussed later.

FIG. 1B also shows examples of the administrative access privileges as represented by the five dashed boxes 150, 152, 154, 156, and 158 located on the right side of the drawing.

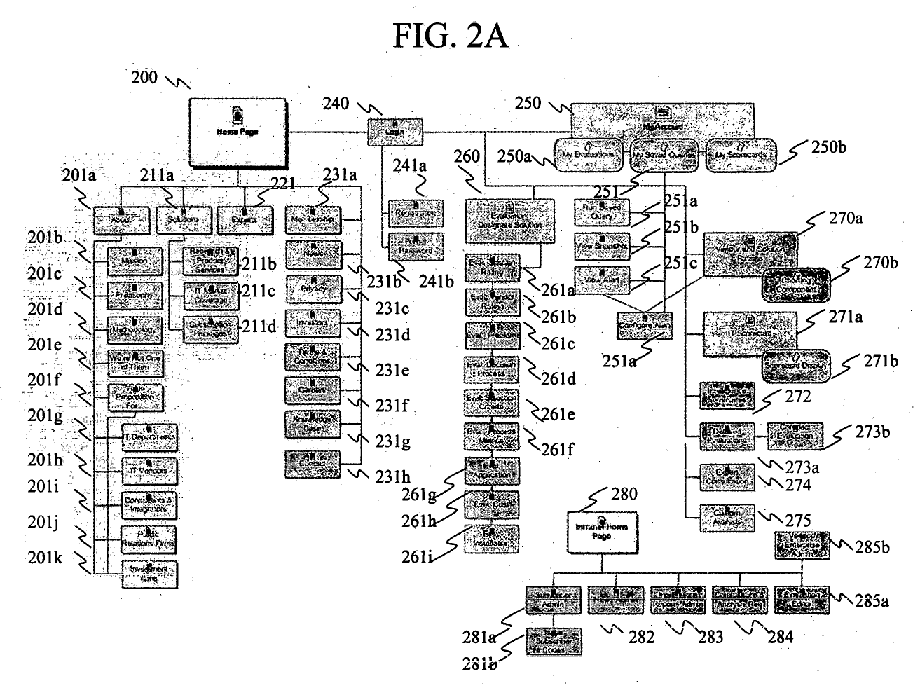

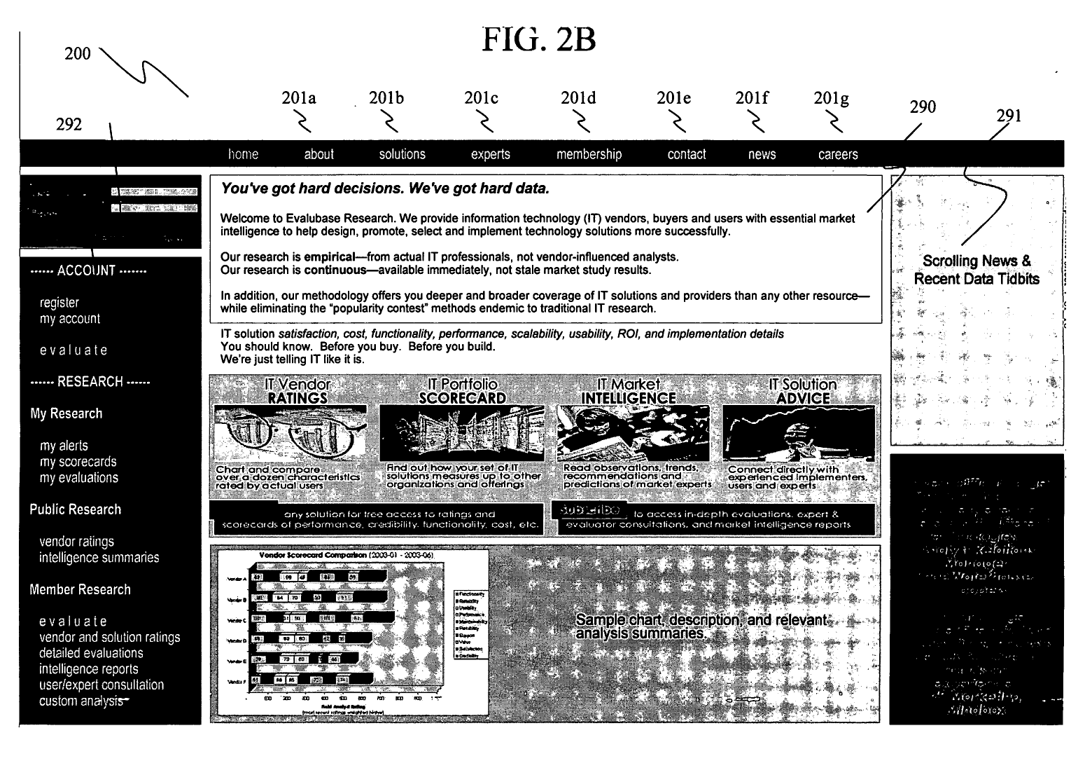

FIG. 2A is a Website flow diagram showing the entire system interface (other branding and navigational elements can be implemented on a page by page basis) according to an embodiment of the present invention. FIG. 2B illustrates an example of the Home Page 200 of FIG. 2A.

From the Home Page 200, a user that requests the site in a web browser has access to areas which include an “About” link 201A, a “Solutions” link 211A, an “Experts” link 221, and a “Membership” link 231A. Registered or existing users may “Login” 240 with a valid name and password and the system will retrieve the user's rights and render a “My Account” page 250, and an “Evaluation” page 260 in the browser that serves as a starting point for navigation of the features. From the “My Account” page 250, a user may view or update evaluations, queries, and scorecards by selecting a link for “My Evaluations” 250A or “My Saved Queries” or “My Scorecards.” From the “Evaluation” page 260, a logged-in user may also select links for evaluation of a product they have implemented such as those shown in text boxes 261A-261I. Alternatively, a user may generate “Vendor” and “Solution” ratings 270A or an “IT scorecard” 271 A, view “Intelligence Summaries” 272 and “Detailed Evaluations” 273A, request an “Expert Consultation” 274 or “Custom Analysis” 275. Only a system administrator has access to the Intranet Home Page 280 to process subscriptions, submit news items, maintain intelligence reports, field and dispatch consultation and analysis requests, and edit evaluations as shown by text boxes 281A, 281B, 282-284, 285A, and 285B.

The Home Page 200 shown in FIG. 2B introduces the knowledge base and launches users to other areas of the site. The Home Page 200 allows a user to browse links on the Website such as an about page 201A for further describing the knowledge base, a solutions page 201B, an experts page 201C, and a membership page 201D. Links to all pages will not be discussed.

The Website of the present invention includes functionality for the following activities and information in FIG. 2A:

1. Statement pages (for example, mission 201B, privacy 231C, quality, and legal)

2. Field analyst, subscriber and market analyst registration 241A & “my account” 250

3. Evaluation submittal 260 (online form, download template, upload form) and online edit

4. Evaluation searching & reporting (query building)

5. Data analysis presentation (for example, indices) & data download (for example, spreadsheet format and comma-delimited format)

6. Market analysis searching, viewing and download

7. Subscriber alerts and alert/notification setup 251A

8. User comment submissions

9. Partner information—listing partners and partner benefits

10. Administrative (internal) pages (for example, database maintenance, performance reporting)

Users may browse the public research and private research areas of the Website using a navigation bar, which is combined into a single navigable submenu 292.

When a user with inadequate credentials attempts to access a feature unavailable to them, they will be challenged with any of the following:

1. Grayed out input controls (showing what they would be able to query if they were to subscribe) or

2. Static sample data with an invitation to subscribe (again showing what they are missing) or

3. A simple message that subscription is required to access the feature.

Modifications of the Home Page 200 shown in FIG. 2B may include:

1. Resizing the “Description of Services” section 290 occupying central part of Home Page 200 to accommodate other important elements “above the fold.” This phrase refers to focusing on what shows up on a page without scrolling in order to sell the page—or the site. Website designers try to make sure that when people see the first screen, they scroll or use a pull-down menu rather than hitting their “back” button to return to the most enticing part of the Website.

2. A “News Ticker” 291 (a scrolling news bar that is continuously updated by the system) can be made static and items can be displayed vertically in descending order starting at a point above the fold, such that returning users can always see fresh information on the Home Page 200 without having to scroll down or wait for the ticker to “loop” (return to the beginning).

Further modifications may include subscribers electing to sponsor custom studies to supplement the standard research. These agreements will not be handled via the Website; however, data collection will be done using the established primary research process.

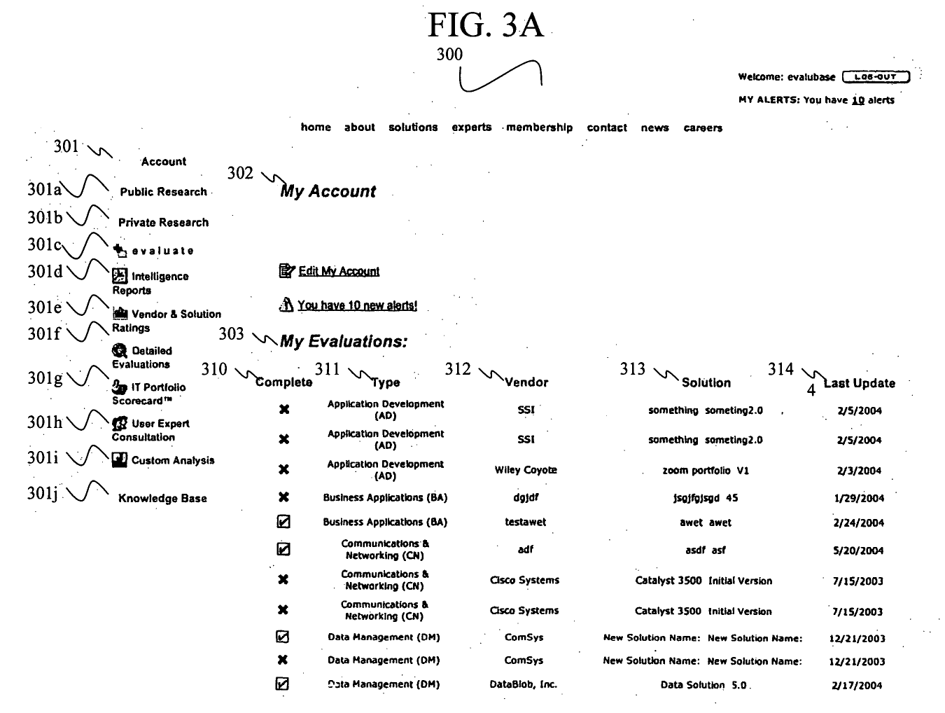

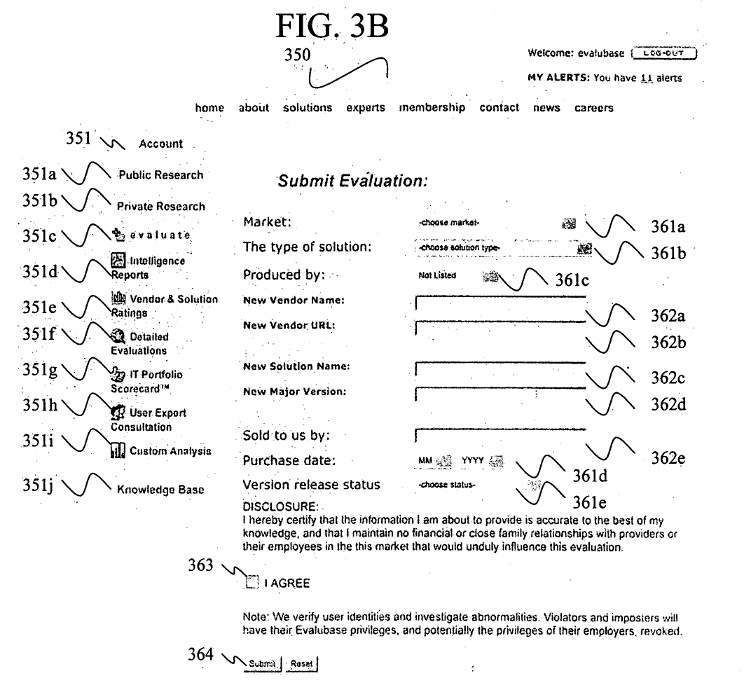

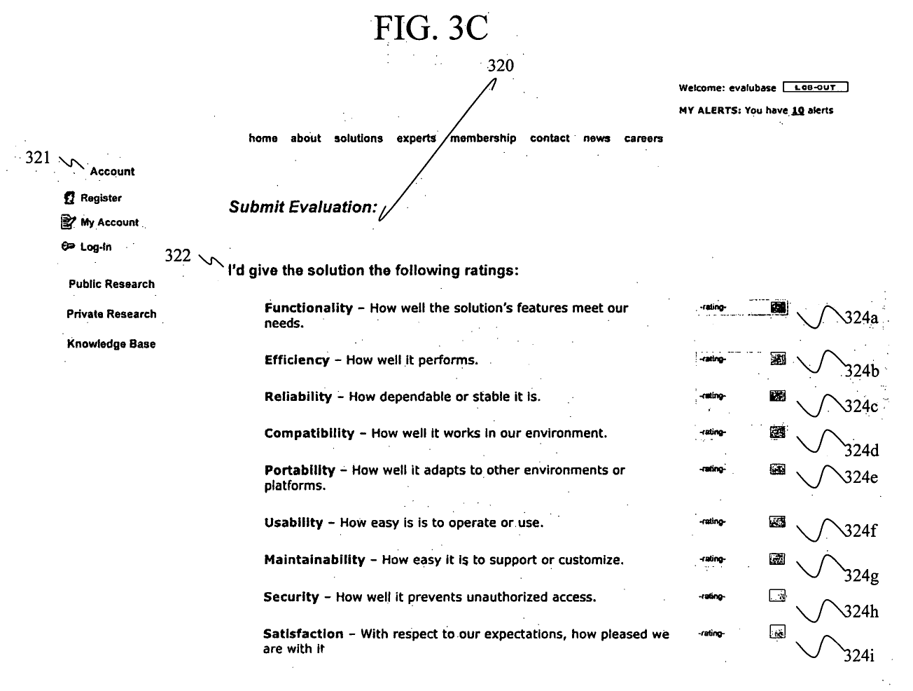

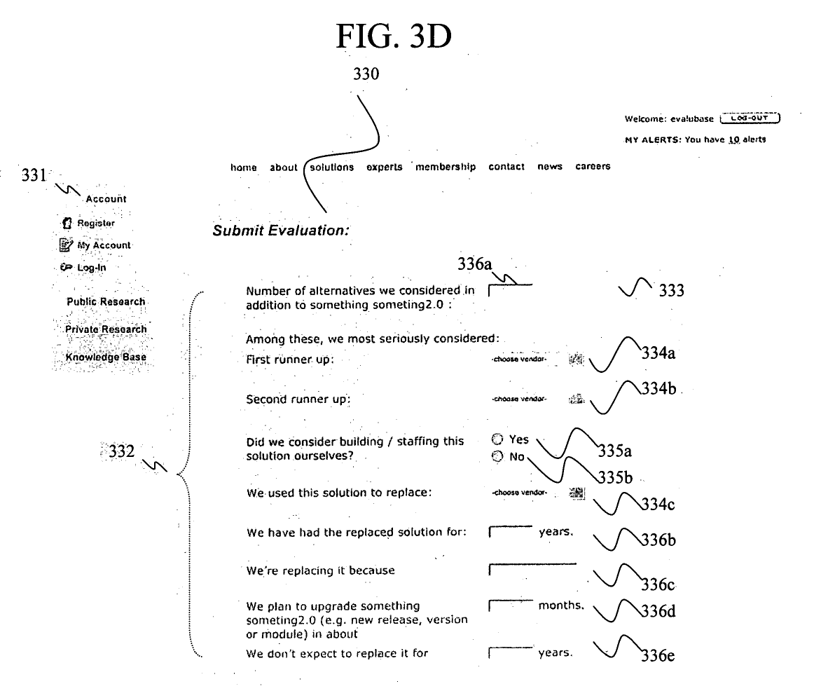

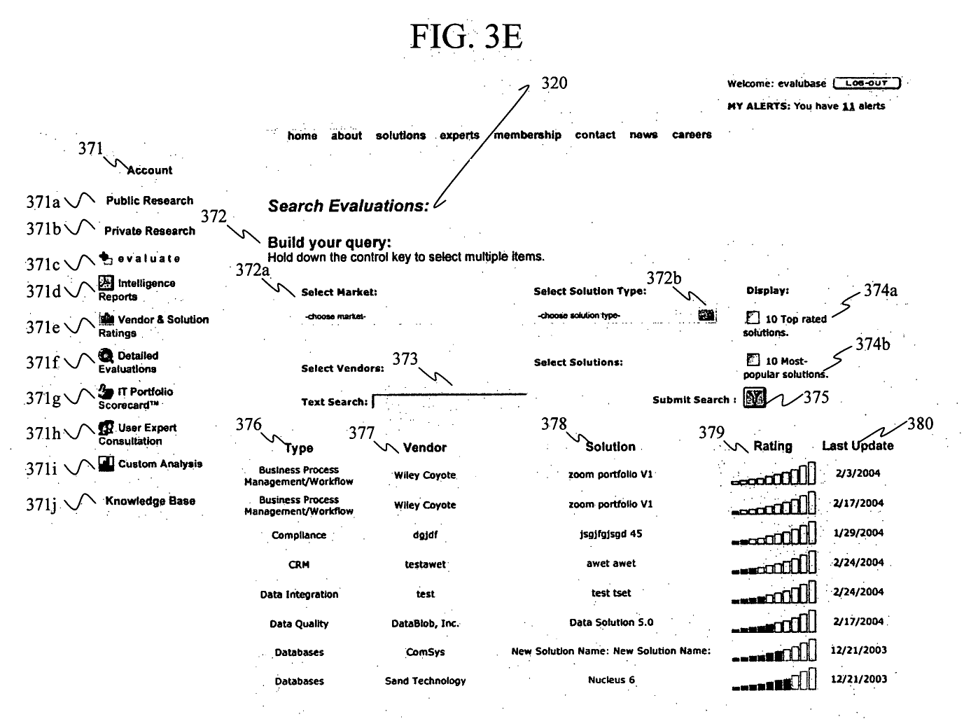

FIG. 3A illustrates an exemplary account showing a list of a particular user's public evaluations according to an embodiment of the present invention. FIG. 3B illustrates an exemplary first page of a survey. FIGS. 3C-3E illustrate additional exemplary forms for completing a survey according to an embodiment of the present invention.

Subscribers (such as vendors, businesses, consultants), which are users of the site whose identity has been verified through a registration process and has additionally paid a subscription fee or used a subscriber code to gain permission to access the EKB for the duration of the subscription period, have full access to particular evaluations, data and research reports. This full access also includes rich online reporting of comparative data and historical trends, custom research alerts, written market analyses, and consultations with evaluators and market experts (an industry analyst individual retained enlisted and contracted, but not hired for the specific purpose of supplying professional research for example, written analyses, about the IT industry and advising subscribers by phone/email). Subscribers have IDs and passwords equivalent to the number of users they contract. They can also elect to download particular evaluations, data analysis and market reports. Vendor-subscribers, hoping to generate more hard data and analysis about how their products are perceived, can encourage their customers to submit evaluations.

Field analysts, who include any IT professional and user of the Website who has submitted evaluations on products used, such as enterprise technology implementers, end-users and managers, have limited access to the knowledge base and the research. This limited access excludes the ability to view individual evaluations and to receive market analysis reports. IT departments achieving evaluations goals (for example, 10% of their employees contributing monthly) will receive a periodic assessment of how their IT portfolio (technologies, consultants, standards) stacks up to enterprises (the company or entity, for example, government organization, or subsidiary) for whom a visitor or subscriber works which may (but does not have to) coincide with a company in the vendor list. If the enterprise is a company in the vendor list, special features are available enabling the user to view data related to his enterprise. It is also assumed that each user belongs to one and only one enterprise in their industry and in general. This will help them plan strategically for upgrades and select higher-value IT solutions. New subscribers that exceed monthly goals for submitting evaluations can receive discounted subscriptions to the system.

Evaluations include both qualitative (written) and quantitative (ratings) assessment of the field analyst's experience with the technology and its provider. For simplicity and cross-solution analysis, evaluation format and questions are standardized and common across all types of technologies. These structured evaluations collect multi-dimensional ratings of solutions and providers, along with details about the selection, implementation and deployment experience. Evaluations include various ratings (for example, satisfaction, value, difficulty), and descriptions (for example, project, selection process, implementation process). Data analysts create and update reports and indices against the quantitative evaluation data.

The process of gathering data for the EKB introduces a standardized survey vehicle for any/all types of enterprise IT products or services. It enables the cross-product analysis of ranking and other quantitative data. This database tool allows users to generate reports and charts by eliciting useful answers from all of the stored data using pre-formulated questions (queries).

Note that the knowledge base for providing or facilitating access to market data and other services can be a variety of devices. Such devices include personal digital assistants, personal messaging units, personal computers, wireless handsets or devices, or equivalents thereof, provided such devices are arranged and constructed for operation in an interconnected system of networks that connects computers.

The Evaluation Knowledge Base used by this system is a continuous (rather than point-in-time), massive, expanding, online, searchable, analyzable storehouse of experiential evaluations of enterprise-class IT solutions submitted by actual IT professionals. The evaluations may include products (for example, software, hardware), services (for example, consultants, educational programs, outsourcers), and standards (for example, communication protocols, architectures, methods). The knowledge base is capable of receiving a continual stream of evaluations from actual technology users to provide IT vendors (a company offering IT solutions for which evaluations may be submitted) the needed competitive intelligence to design better solutions and market them optimally.

An evaluation is a fixed, pre-determined set of forms that users fill out and whose data is aggregated as the basis for vendor/solution rating, and for scorecards. As shown in FIG. 3A, a logged-in user that has subscriber level access may access his/her account to conduct public research 301A, private research 301B, or access the knowledge base 301J by following the appropriate links. A logged-in user may submit an evaluation by selecting a link to “evaluate” 301C a product they have implemented.

The user in FIG. 3A has clicked on the “Account” button 301 to access his/her account information. A user may access data in the EKB by clicking on the “Private Research” button 301B. The categories of data in each column shown under “My Evaluations” 303 may be sorted in ascending/descending order by clicking on the column titles “Complete” 310, “Type” 311, “Vendor” 312, “Solution” 313, and “Last Update” 314. The “Complete” column 310 provides an “X” (representing an incomplete evaluation) or a “√” (representing a completed evaluation). The “Type” column 311 lists the categories for the products listed in the “Solution” column 313 provided by the companies in the “Vendor” column 312. This page also lists a column for “Last Update” 314. Clicking on the desired evaluation line may open completed or incomplete evaluations.

A user can submit, edit, update, or view an evaluation. The system presents the user with a sequence of forms similar to FIGS. 3B-3E, each corresponding to a subcategory of the evaluation. The system presents a sequence of dynamic drop-down boxes, radio buttons, or blank boxes, allowing the user to either select the exact solution name from a list or type in the vendor and solution name manually as text. The system identifies the solution based on the user input (either by exact match or fuzzy match) and creates a new solution record if one does not already exist. Having identified the product, the system creates a persistent record for the evaluation and presents the remaining forms in the evaluation sequence to the user. As the user submits each form in the sequence, the system validates the data and challenges the user for alterations whenever invalid data is presented.

A user wishing to submit an evaluation clicks on “evaluate” 351C and completes the first page shown in FIG. 3B. The form invites the user to identify the product and version number about which they are reporting. A user may click on options listed in pull-down menus for “Market” 361A, “Type of Solution” 361B, “Produced By” 361C, “Purchase Date” 361D, and “Version Release Status” 361E. This form also includes blank boxes 362A-362D for new information and “Sold to us by” 362E. A user moves to subsequent forms by checking the “I Agree” button 363 and by clicking on “Submit” 364.

On the form 320 shown in FIG. 3C a user can rate different categories for a solution listed in column 322 using a pull-down menu 324A-324I. On form 330 shown in FIG. 3D a user can rate a solution by using the categories listed in column 332 using either pull-down menus 334A-334C, radio buttons 335A and 335B, or blank boxes 336A-336E as shown in column 333.

Alternatively, except at any point after the system has accepted the form identifying the product to be evaluated, the user may abandon the form by navigating to another area of the site, navigating to a new site, or closing their browser window. The system stores the incomplete evaluation record and will make it available for completion at a later date.

A logged-in user may edit an evaluation by clicking on a link in the “My Evaluations” list 303 shown in FIG. 3A for one of the evaluations already submitted and stored in the system. The system retrieves the record for the particular evaluation and displays the first page of the evaluation form. The system displays individual data fields inside editable controls except for the data identifying the unique solution name, vendor, and version number. As the user navigates to each subsequent form, newly input or altered fields are validated and updated in the system. The date-stamp on the evaluation is also updated to the current system date as shown in the “Last Update” column 314 of FIG. 3A.

Alternatively, if the user again abandons the evaluation before all controls contain valid responses, the system will maintain the status of the evaluation as incomplete, and it will continue to appear as an actionable item on the “My Evaluations” list 303 shown in FIG. 3A.

A logged-in user can update an evaluation with data resulting from an upgrade experience by clicking a link in the “My Evaluations” list 303 shown in FIG. 3A for one of the evaluations already submitted and stored in the system. The system retrieves the record for the particular evaluation and displays the first page of the evaluation form. The system displays individual data fields inside editable controls except for the data identifying the unique solution name, vendor, and version number. Because the user wishes to update the evaluation based on an upgrade experience, the use may click a button next to the version number indicating the desire to change that field and submit a new evaluation using the old one as a template. The system re-displays the data fields corresponding to the unique solution name, vendor, and version number-with the version number now editable. When the user navigates to the next page, the version number is validated positively only if it is different from the version on the original evaluation. When the version number validates, a new evaluation is created in the system that is populated with data from the original. As the user navigates to each subsequent page, newly input or altered fields are validated and updated in the system. The date-stamp on the evaluation is also updated to the current system date.

Alternatively, if the version number does not validate or is not different from the original version number, the system does not allow the user to proceed with the evaluation and will not store a new copy of the evaluation.

A logged-in user may view compact detailed evaluations submitted by others by clicking a link to view a “Detailed Evaluation” 371F of FIG. 3E and is presented with a series of drop-down boxes that lead the user to “Select Market” 372A and/or “Select Solution Type” 372B and a blank box for “Text Search” 373. The system, having identified the solution criterion, displays a table of all submitted evaluations for the selected solution with one-line summary level data. The one-line summary level data includes “Type,” “Vendor,” “Solution,” “Rating,” and “Last Update” as listed in columns 376-380. The system only shows completed evaluations in the summary and never identifing information about who or what organization submitted them. The user then selects any of the individual evaluation records from the list, and the system responds by retrieving the evaluation data and displaying it in a single-page compact form (that does not involve input controls). The user scrolls and/or pages through the data using navigation buttons, and when the user reaches the end and clicks on the final navigation control, the system redirects the user back to the one-line summary records for the solution.

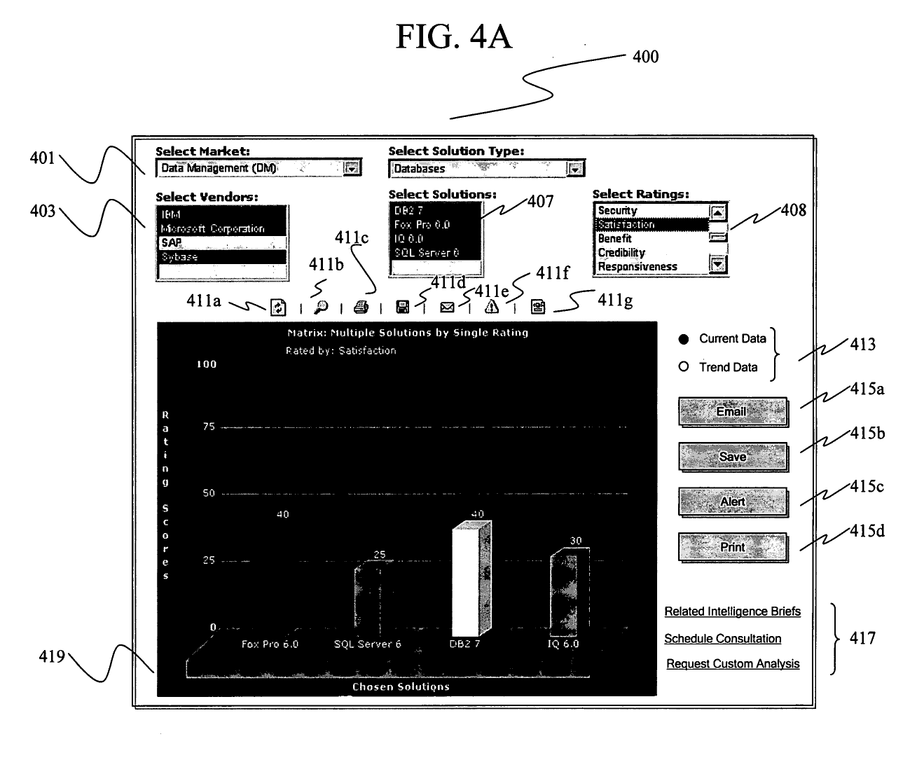

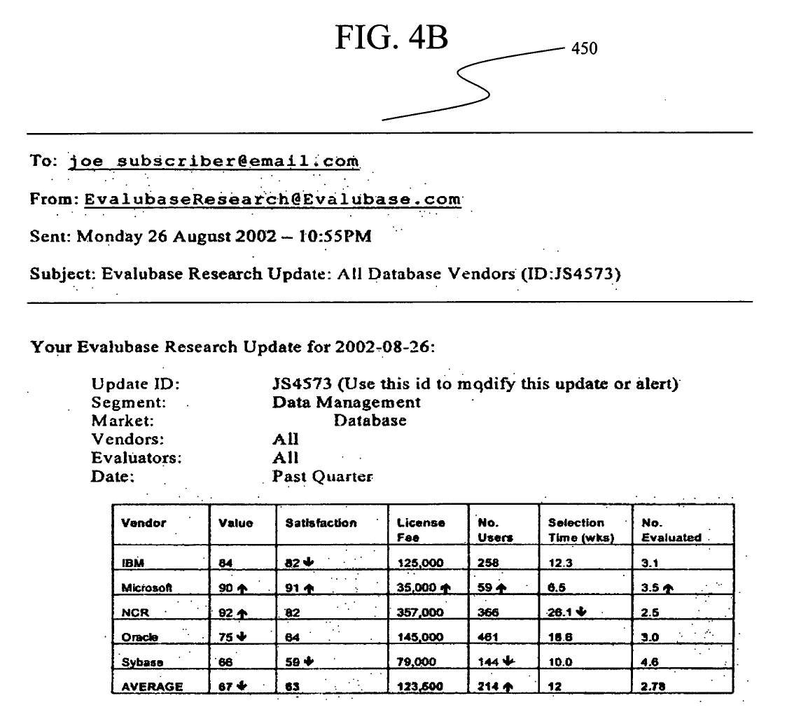

Actual surveys completed by users are made available for viewing by subscribers. Information that might allow a user to ascertain the individual's or his/her employer is concealed from viewing. The evaluations discussed in reference to FIGS. 3B-3E are used as the basis for “Vendor” and “Solution” ratings discussed in reference to FIGS. 4A and 4B which are other options listed under “Private Research” and will now be discussed. The evaluations are also the basis for IT Portfolio Scorecards (discussed later).

FIG. 4A illustrates an exemplary vendor/product rating chart 400. FIG. 4B illustrates an exemplary research update alert 450 sent to a user via e-mail.

A user in the “Private Research” area shown in FIGS. 3A-3E that has clicked on “Vendor & Solution Ratings” may indicate the parameters of a query using categories 401-409. The answers to the query generate online charts of aggregate survey data (rating scores) submitted to the EKB and the resulting information is shown as chart 419. A user may query the knowledge base by inputting criteria to drive the retrieval of aggregate rating data from submitted evaluations. Criteria may include the-categories shown in FIG. 4A such as “Select Market” 401, “Select Solution Type” 405, “Select Vendors” 403, “Select Solutions” 407, and “Select Ratings” 409.

As can be seen from chart 419, the user has selected multiple solutions as listed in the “Select Solutions” pull-down menu 407 and selected a single rating (satisfaction) from the “Select Ratings” pull-down menu 409. From the chosen solutions, Fox Pro 6.0 and DB2 7 have a rating of 40, SQL Server 6 has a 25 rating, and IQ 6.0 has a rating of 30.

Charts created can be saved, re-run (dynamic or static) and sent right to a desktop or hand-held computer on a chosen schedule. Parameters for the queries can be saved for retrieval and re-execution at a later date, for example, periodically (daily, weekly, monthly, quarterly). Saved queries may potentially show a different result as a consequence of changes to the underlying data. Users may also elect to be alerted whenever the underlying data for this query changes. The queries can be re-executed and the user has the option of receiving the resulting chart and/or a link by email (see FIG. 4B) or by other messaging devices. Options including printing, email, saving, and an alert are shown by the buttons 415A-415D. The group of icons 411, some of which are well-known, indicates further options for viewing the chart 419.

Anyone who submits an evaluation can perform online graphical analysis of the quantitative data for any IT market, solution type, solution, or provider such as shown in FIG. 4A. Non-subscribers can access overall ratings whereas subscribers can access detailed ratings (for example, performance, value, satisfaction, usability) other quantitative data (for example, implementation times, costs, ROI). Here trends can be spotted and IT solution ratings can be compared.

The system delivers the ratings, experiences and insights of actual IT professional right to a desktop or hand-held computer, and enables a user to connect directly with them regarding a specific situation. Up-to-date ratings of IT providers and their solutions are provided based on hard data. Self-service online analysis of the data, custom alerts, customized surveys, and the means to track and valuate benchmark an IT portfolio is also offered.

A user, having just executed a vendor/solution rating or other quantitative data query, may click an icon to “Save” 415B the query. The system will then remember the parameters entered for the query and subsequently display it as a line item in the user's “Saved Queries” account category. This feature is not shown in the drawings.

A user viewing a “Vendor/Solution Rating” report may desire to save an exact snapshot of the current data. The user clicks an icon for “Save Snapshot” and the system archives the data in their report for future retrieval. This feature is not shown in the drawings.

A user, perusing their list of “Saved Queries,” may re-execute a saved query or snapshot by clicking on any individual line-item query. The system retrieves the parameters for the query and redirects the user to the “Vendor/Solution Rating Report,” re-executing the saved query or re-displaying the saved snapshot. This feature is not shown in the drawings.

A user, perusing their list of “Saved Snapshots” may view a saved rating snapshot by clicking on any individual line-item snapshot. The system retrieves the entire data set for the snapshot and re-renders it using the charting component exactly as it was seen when originally requested. This features is not shown in the drawings.

A user may request an alert after executing a query for a vendor or solution rating by clicking on the “Alert” button 415C. The system launches a daughter window from the user's browser requesting the parameters of how the alert will be delivered. The parameters include a unique identifier for the alert, how frequently the alert will be sent and the method of delivery (email or otherwise). A modification of the current capabilities for request an alert may include a percentage number representing the degree of variation (±) from the currently displayed rating that will serve as a threshold to trigger the delivery of a new alert. The user provides valid parameters and presses “Save Alert,” (the daughter window pops up after pressing the “Alert” icon 411F) causing the system to store the parameters and a reference point (the current numeric vendor/solution rating) from which the system may later decide whether new/updated/deleted data has caused an alert to trigger.

Alternatively, from within the daughter window, if the user supplies invalid or inadequate parameters and when “Save Alert” is pressed, an error is displayed in the same daughter window describing as specifically as possible which parameters need to be updated.

Further, from within the daughter window, if the user presses “Cancel,” the system will disregard any of the parameters that may have been input to the user. The user is returned to the query results.

After the user has set up an alert, the system triggers the alert internally based on either the frequency criterion having been met or a data having been added/updated/deleted. The system creates an alert message in the user's alert queue and increments the number of “new alerts” wherever that notification is shown. The user sees the “new alert” and clicks it to see a summary of their alert messages. The user then clicks the newly delivered message to read its content, causing the system to flag the alert message as read (no longer “new”). This features is not shown in the drawings.

Alternatively, after the user has set up an alert, the system may trigger the alert internally based on either the frequency criterion having been met or data having been added/updated/deleted. The system transports the alert message to the user, including summary level text of the alert message content and a Web link inviting the user to view the full contents of the alert. When the user clicks the URL (or types it in their browser), the system displays the content and flags the message as “read.”

Further, after the user has set up an alert, the system may trigger the alert internally based on either the frequency criterion having been met or data having been added/updated/deleted. The system transports the alert message to the user, including summary level text of the alert message content and a Web link inviting the user to view the full contents of the alert. The user chooses to read the alert message and continues with another task. The alert in the system remains flagged as “new” and will appear as such when the user logs in to the site at a future time.

Upon browsing through their delivered alerts, a user may select an icon to suppress future delivery of the particular alert or by editing an existing alert and deselecting parameters for delivery. The system, having identified for which record the icon was clicked, alters the configuration for that particular alert to indicate that it is no longer active. The user does not receive the alert ever again.

Alternatively, upon browsing through their alert configurations in the “Saved Queries” list, a user may select an icon to suppress future delivery of the particular alert. The system, having identified for which record the icon was clicked, alters the alert configuration for that particular saved query to indicate that it is no longer active. The user does not receive the alert ever again.

From the “Saved Queries” list, the user may delete a saved query (including alerts or snapshots) by selecting a button next to any given saved query indicating he wishes to “Delete” it. The system responds with a confirmation page and requests the user to choose from one of: “Delete the Saved Query Now,” “Delete Only the Alert,” or “Don't Delete Anything.” When the user chooses, “Delete the Saved Query,” the query is deactivated and never shown again. The system redirects the user back to the list of saved queries. This feature is not shown in the drawings.

Alternatively, the user may choose to delete only the alert. If there is an alert associated with the saved query, the system removes the alert from the saved query and redirects the user back to the list of saved queries.

Further, the user may choose “Don't Delete Anything.” The system does nothing but redirect the user back to the list of saved queries.

Having navigated to the “Vendor/Solution Rating” page, the user may request vendor rating or solution rating by populating a sequence of drop-down boxes that lead to the selection of an individual “Vendor Name” or, if the credentials are valid for the vendor and the subscription period is currently active, “Solution Name.” Having identified the record that will serve as the primary criterion for the query, the system presents the user with “Vendor Rating” dimensions” and “Solution Rating” dimensions. Other quantitative data may also be listed and queried. After the user selects one or more non-grayed listed quantitative data identifiers, the system requests aggregate data from the “Query Engine” and feeds it to the “Charting” component that renders a graphical representation of the data on the user's screen. This feature is not shown in the drawings.

While viewing a vendor or solution rating report, a user may save vendor of solution rating reports by clicking an icon representing “Save” 411D, causing the system to prompt the user with a file name. The user responds with a file name and the system saves the raw report data in XML format to the user's local hard drive.

The saved report may be opened in a spreadsheet outside of the context of the system. After double-clicking on the saved report file, the contents will be displayed in a spreadsheet format for the user to manipulate as needed.

While viewing a vendor or solution rating report, a user may print the report by clicking on an icon representing “Print” 411C, causing the system to send the pre-formatted report (minus all surrounding page elements) to the user's local printer.

While viewing a vendor or solution rating report, a user may send the report to a friend by clicking an icon representing “Email” 411E, causing the system to display a form that requests contact information about the user to whom the report will be sent. The system sends a preformatted HTML email message to a specified email address showing the user's message and the report data.

From the page where the chart 419 is generated, a user may also “Request Custom Analysis” or a user-initiated request for a data query whose criteria fall outside what is available in the vendor/solution rating feature and IT Portfolio Scorecard feature (discussed later) of the Website. A user may also “Read Intelligence Briefs” or “Schedule a Consultation.” The group of links 417 indicates these three options which will be discussed later. Further modifications to all pages with a dynamic query template (“Vendor Rating” and “Solution Rating,” “Detailed Evaluation,” “Request Custom Analysis,”) include adding some visual cues to assist users through the dynamic query building process and to let them know there is an additional step forthcoming so that they don't abandon the query due to confusion.

The reporting engine discussed above generates XML data for the charting component based on the query parameters submitted to it. The query building process is dynamic since the data or the query parameters may change. The process of aggregating the data will now be discussed.

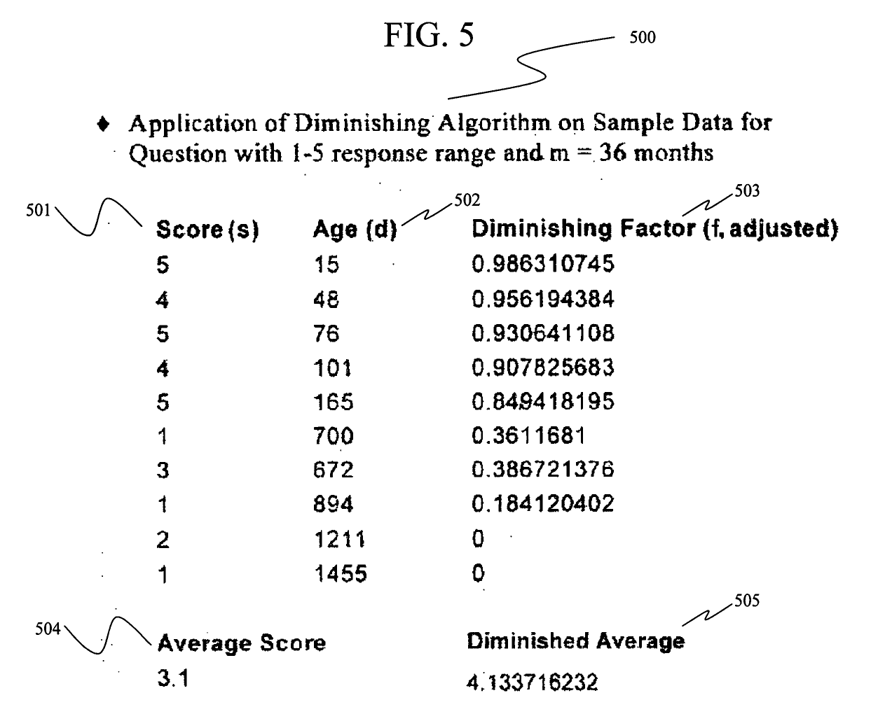

FIG. 5 illustrates an exemplary application 500 of a diminishing algorithm of sample data.

The purely empirical process includes a “diminishing weighting” algorithm that reduces the impact of a rating on the overall score as the evaluation becomes older (or ages). The survey data that is collected is immediately available via updated ratings. That is, more current evaluations contribute more heavily to the current ratings of the survey data for a product or service.

Different algorithms are used to aggregate the data along any of the vendor or solution rating dimensions as follows:
1. Diminished Score: A number (D in the equation below) representing a raw score (s) 501 whose magnitude has been lessened relative to the age of its evaluation for the purpose of consideration alongside other scores in various stages of decay.
The parameters include age 502 expressed in days and designated (d). The duration over which the score is aged is expressed in months and designated m; any D whose age exceeds m becomes 0.
The calculation is performed on a raw score designated (s) 501. A diminishing score D decays linearly such that at point d=0, D will equal (s) wholly undiminished. At the limit of the duration specified by m, D becomes 0. The slope of the line in the interval [0, m] is 1/m and from [m, infinity] is 0. A diminished score may decay non-linearly due to unreasonable data inputs.

Conceptual calculation: Diminished Score=Raw Score*[Upper Limit of Scale−(# Days Old*Increment of Diminishing Period in Months*Conversion Factor of Days into Months*Inverse of Upper Scale Limit)]
The diminished score D is of no value except in relation to its diminishing factor (f) 503 and when aggregated with other diminished scores in relation to the sum of all their diminishing factors 503. D should never appear independently because it could be misconstrued as a qualitative diminishing on the score (s) 501 rather than as a diminished consideration of score (s) 501. Output which is correctly calculated on the basis of D will have qualitative values consistent with the raw score (s) 501.
Numerical calculation: D=s*[100−(d*1/m*12/365.25*1/100)]
Simplification where score diminishes over a period of m=36 months
   D=s*[100−(d*1/36*12/365.25*1/100)]
   D=s*(1−0.000912617d)
The number 0.000912617 derived from m=36 is known as the Weight w
The term (1−wd) is known as the Diminishing Factor (f) 503. Conceptually, f is the multiplier used on the raw score (s) to produce its diminished impact relative to its age in days (d).
Example where score is 250 days old: D=s*0.77184575 (s is diminished to 77% of its original value).
Example where score is 912 days old: D=s*0.167693296 (s is diminished to 17% of its original value).
To prevent negative Diminished Scores (where the age of the evaluation exceeds the length of the diminishing duration m months) having a generic algorithm to squelch negative diminishing factors should be considered to allow for adjusting the value of m in real time without having hard coded conditions that assume a fixed value for m.
Conceptual algorithm: Legitimate diminishing factors of the form f=1−wd have results in the range between 0 (meaning the score is disregarded due to age) and 1 (meaning the score fully impacts the average without diminishing). To squelch scores that are too old, legitimate values of f are shifted below 0 by subtracting 1 and then negated further by subtracting the absolute value of the inverse of f to render double the original result (negated). Because illegitimate values of f will remain positive after subtracting one, subtracting the inverse of those values will zero them out. Dividing final results by two and taking the absolute value restores all legitimate values of f and leaves expired values (older than m months) with a diminishing factor of 0.
Values shown inside 1's are absolute values and take operational precedence over addition, subtraction, multiplication, and division but not over parentheses.
   D=s*|(wd−1−|wd−1|)/2|
   Example where m=36 and score is 1636 days old: I=s*|0.493−|0.493|/2|→W=s*0 Example where m=36 and score is 165 days old: I=s*|−0.84941−|−0.84941|/2|→W=s*0.84941
2. Application of Diminishing Factor to an Averaging Algorithm: Standard non-weighted averaging algorithm 504: (s₁+s₂+S₃+ . . . +sₙ)/n
The denominator of the algorithm (n) is a count of the number of terms summed in the numerator; to diminish the denominator, the overall contribution of each term must be diminished to the denominator by multiplying each whole count value of 1 (in this case scores having a values selected from the group 1-5) by the diminishing factor f. Therefore, the diminished term count (505)=f₁*1+f₂*1+ . . . +fₙ*1→f₁+f₂+ . . . +fₙ
Conceptual weighted algorithm: Based on the standard averaging algorithm, every (s) 501 becomes a diminished score (D), and the denominator n takes on the sum of the diminished term count (f₁+f₂+ . . . +fₙ); in other words, diminished scores do not pull down the overall average simply because they are aged but rather contribute to the average with a degree of magnitude inversely proportional to their ages.
Diminished averaging algorithm based on pre-calculated weight: (D₁+D₂+ . . . +Dₙ)/(wd₁−1−|wd₁−1)/2|+|(wd₂−1−|wd₂−1|)/2|+ . . . +1(wdₙ−1−|wdₙ−1|)/2|
The algorithms discussed above are used by the system to generate an IT scorecard from the aggregate survey data (scores).

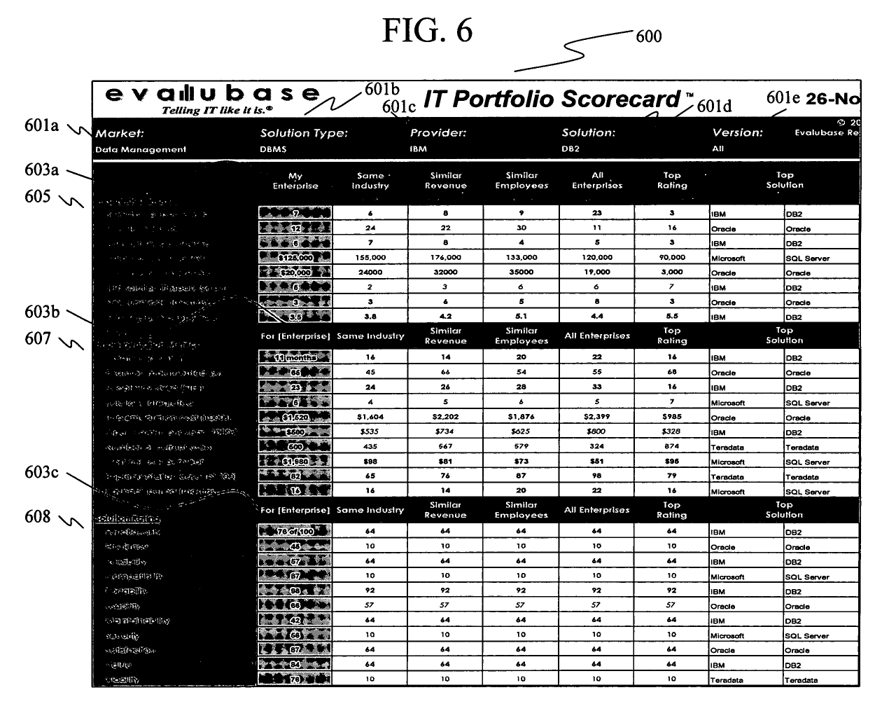

FIG. 6 illustrates an exemplary IT portfolio scorecard 600. While in the “Private Research” area discussed earlier, users may generate a scorecard 600 for any or all IT products/services and vendors for which they have submitted an evaluation (survey).

After submitting query parameters that are constrained to the set of solutions on which the user has submitted an evaluation, a densely formatted scorecard comprised of tabular rating data with an emphasis on comparing other industries' experiences and competing solutions to the one evaluated by the user may be generated.

Scorecards contrast key indicators (for example, performance, functionality, scalability, and cost) against averages for that product/service/vendor overall, and versus enterprises (in aggregate) of similar industry, geography, size, and revenues. Scorecards also indicate top performing alternate solutions for each indicator. The category headings represented by 603A-603C show exemplary data contrasting the key indicators.

The term “Scorecard” is a trademarked term for a side-by-side comparison of an enterprise's aggregate evaluation data (specifically, the acquisition metrics 605, implementation metrics 607, and solution rating 608) to: 1) the aggregate data in the same categories submitted by other affinity groups (for example, industry, size, revenues) for the exact same solution, and 2) the top rated solution in the category. The level of detail on the IT Portfolio Scorecard is configurable at the solution level, solution type level, vendor level, or market level.

IT departments, participating organizations, and subscribers that register are given periodic assessments of their “IT portfolio” in exchange for their staff completing evaluations. Assessments include scorecards of how each of their selected IT solutions compares to selected similar solutions and similar organizations their geography and of similar size. The scorecard is a detailed, value-based, and comparative inventory of IT assets (individually and in aggregate) and evaluated solutions. The scorecard suggests upgrade/replacement timeframes and recommends alternatives. Registered organizations may also add custom survey questions for enhanced staff polling. The more solutions an IT staff submits evaluations for, the more comprehensive the scorecard.

A logged-in user may request and IT portfolio scorecard on the Website and the system presents the user with a sequence of drop-down boxes and other filters to select available scorecards by “Market” 601A, “Solution Type” 601B, “Provider” 601C, “Solution” 601D, and “Version” 601E, for example. The system, responds with a preformatted set of tabular data representing high-level summary and comparison information for all matching scorecards. Clicking on one of the rows displays the corresponding scorecard. The drop-down boxes and other filters are not shown in the drawing.

While viewing a scorecard, a user may print a scorecard by clicking an icon representing “Print,” (not shown) causing the system to send the pre-formatted scorecard to the user's local printer.

While viewing a scorecard, a user may save a scorecard on a local machine by clicking an icon representing “Save,” (not shown) causing the system to prompt the user with a file name. The user responds with a file name, and the system saves the raw scorecard data in XML XLS format to the user's local hard drive.

While viewing a scorecard, a user may refresh a scorecard by clicking an icon representing “Refresh,” (not shown) causing the system to re-query the underlying data (for changes) and redisplay the scorecard.

A saved scorecard may be opened outside the context of the system to display the contents in a scorecard-formatted spreadsheet for the user to manipulate as needed.

While viewing a scorecard, a user clicks an icon representing “Email” (not shown) to send the scorecard to a friend, causing the system to display a form that requests contact information about the user to whom the scorecard will be sent. The system sends a preformatted HTML email message to a specified email address showing the user's message and the scorecard data.

After submitting query parameters that are constrained to the set of solutions on which the user has submitted an evaluation, a densely formatted scorecard comprised of tabular rating data with an emphasis on comparing other industries' experiences and competing solutions to the one evaluated by the user.

Vertical dimensions (data categories in vertical orientation of the scorecard) may include an:

Acquisition Rating Dimension 605 with categories “People Involved,” “Number of Alternatives Considered,” “Initial Cost (License Fee),“ ”Annual Cost (Maintenance Fee),” “Old Solution Lifespan (years),” “Next Anticipated Upgrade (months),” and “Next Anticipated Replacement (years);”

Implementation Rating Dimension 607 with categories such as “Duration (months),” “Features Implementation (%),” “People Involved (FTB),” “Implementation Cost ($k),” “Operating Cost+Maintenance Per Year ($k),” “Number of Current Users,” “Cost Per User Per Year,” “Implementation Ease (of 100),” “Payback Period (months);” Solution Rating Dimension 608 with categories such as “Functionality,” “Efficiency,” “Reliability,” “Compatibility,” “Portability,” “Usability,” “Maintainability,” “Security,” “Satisfaction,” “Value” (“Solution Rating” dimensions are a predefined and finite enumeration of characteristics, each of which may serve as an axis along which solution evaluation data can be aggregated. These dimensions may include Functionality, Efficiency, Reliability, Compatibility, Portability, Usability, Maintainability, Security, Satisfaction, and Benefit);

Vendor Rating Dimension with categories such as “Credibility,” “Responsiveness,” “Ingenuity,” “Support,” “Vitality,” “Sales Team,” “Marketing,” “Legal & Accounting,” “Development/Delivery,” and “Services & Support.” (“Vendor Rating” dimensions are a predefined and finite enumeration of characteristics, each of which may serve as an axis along which vendor evaluation data can be aggregated.)

Horizontal Dimensions 603A-603C (data categories in horizontal orientation of the scorecard) may include “My Enterprise (data collected from user's evaluation),” “Same Industry (average data collected from evaluations submitted by enterprises in similar industries),” “Similar Revenue (average data collected from evaluations submitted by enterprises with similar revenue),” “Similar Employees (average data collected from evaluations submitted by enterprises in similar industries),” “All Enterprises (average data collected from evaluations submitted by all enterprises),” “Top Rating (minimum or maximum extreme value dependent on field),” Vendor (vendor name who produced top rating solution),” “Solution (top rating solution name),” and “Ranking Description.”

Data may be aggregated differently within the tables based on whether specific markets, solutions, or vendors are selected. Aggregate data also appears at the bottom of each scorecard table in each data category.

Rather than viewing data in a quantitative format, such as by generating charts and scorecards, users accessing the “Public Research” or “Private Research” page may click the appropriate link to view “Intelligence Reports” to view data in the form of a written report.

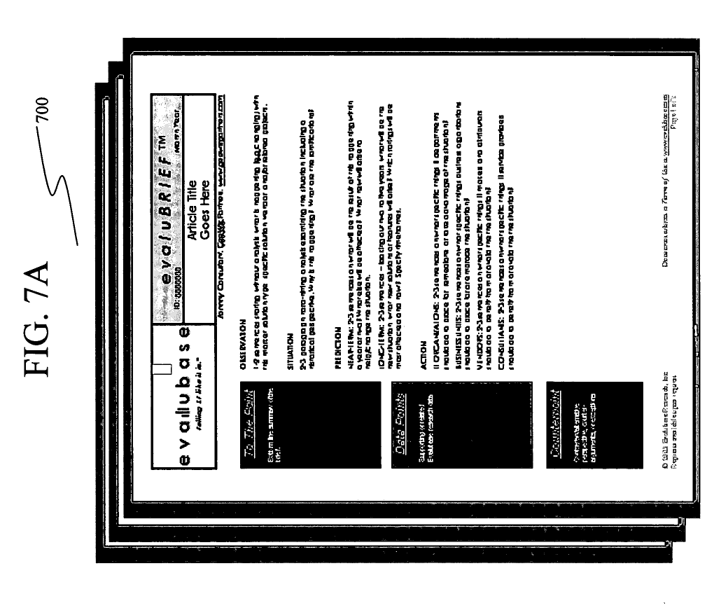

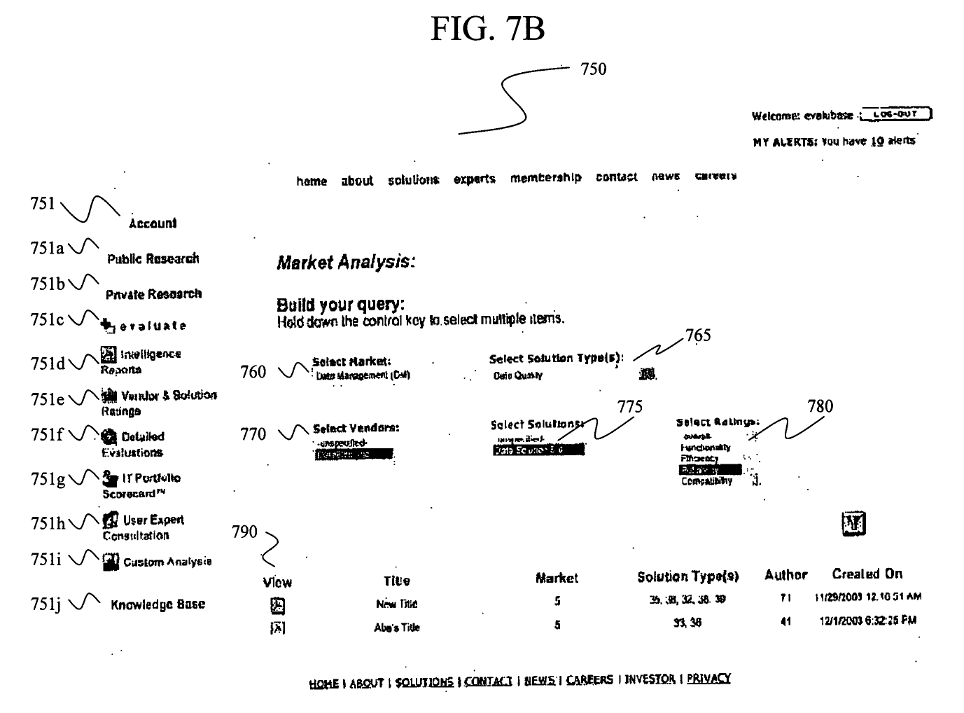

FIG. 7A illustrates an exemplary page that provides a written analysis of a particular market. FIG. 7B illustrates an exemplary page providing results for a queried market analysis intelligence report.

Standardized analyses 700 are written by experts in particular markets. In return, the experts receive subscriber-level access to the research, and are on-call when subscribers request a consultation. Experts are compensated for completing the consultation and submitting discussion notes. The experts are authorized to treat the consultations as qualified leads to promote their own related service offerings.

The written analysis, termed an intelligence brief, is a preformatted document (shown as a PDF “evaluBRIEF™”) containing research data and viewable by subscribers. Draft “Intelligence Reports” are received and edited in using word processing software, but not managed by the knowledge base application.

Thus, a user may request an intelligence report by navigating to the “Intelligence Reports” 75 ID section of the site and the system presents the user with a sequence of drop-down boxes and text search box to select available intelligence reports by “Select Market” 760, and/or “Select Solution Type” 765, and/or “Select Vendor” 770 and/or “Select Solutions” 775 and/or “Select Ratings” 780. The system, responds with a preformatted set of tabular data representing high-level summary and comparison information for all matching intelligence reports. When the user clicks on or arrows to a queried report line item, the system displays the summary information below according to categories represented as headings 790. When a user double-clicks on a report line below the headings 790, the system checks that the user has the correct permissions to view the report and displays the preformatted report in the user's browser.

Alternatively, if the user is not logged in when they double-click on the line item for the “Intelligence Report” 75 1D they wish to view, the system redirects the user to the “Login” page with an explanation that they must be logged in and subscribed in order to view the content. This feature is not shown in the drawings.

Alternatively, if the user is not currently subscribed, when they click on the line item shown by row 790 for the “Intelligence Report” they wish to view, the system redirects the user to the “Membership” page with an explanation that they must become a subscriber in order to view the content. This feature is not shown in the drawings.

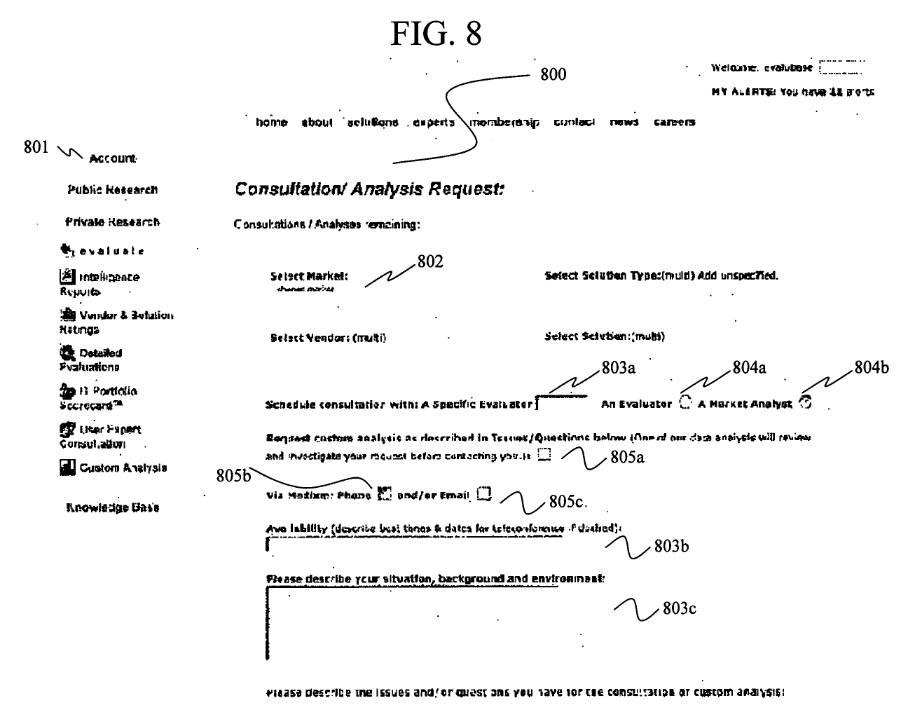

Another feature of the knowledge base is the “Consultation/Analysis Request” 800 which is shown in FIG. 8. A single form is delivered to an analyst in which a user may request, for a fee, to be connected to a consultant in a specific field.

A user may enter data in a pull-down menu 802, blank boxes 803A-803C, radio buttons 804A and 804B, or checkable boxes 805A-805C.

Unlike any other IT research resource, which is often influenced by vendor marketing or hype, a user of the aforementioned evaluation knowledge base of the present invention has access to multi-dimensional ratings of IT solutions for competitors and partners in nearly every market, access to detailed evaluations submitted by actual IT professionals, the option to receive alerts about solutions or providers of interest that may indicate market shift, access to research written by IT professionals actually employed as IT professionals, and access to one-on-one consultations with actual evaluators and hands-on market experts.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An apparatus for collecting and evaluating data about an enterprise for analysis and viewing, the system comprising:
a knowledge base for receiving and delivering data in a computer readable medium;
a user profile having stored information regarding a user, the user profile for granting an access privilege to the knowledge base; and
a survey capable of being run on the computer readable medium, the survey being associated with each user and having a plurality of sections including responses to questions about a particular solution by one or more users,
wherein the responses are for populating the knowledge base with selectively added data received from one or more of the users, and
wherein the user can continuously update a survey associated with the user upon collection of additional data.

2. The apparatus of claim 1, wherein the user is a visitor who has not registered, the access privilege of the visitor including registration and public research.

3. The apparatus of claim 1, wherein the user is a registrant, the access privilege of the registrant including submitting and updating responses to the survey associated with the registrant and private research.

4. The apparatus of claim 1, wherein the responses include ranking data about the particular solution.

5. A method of collecting data for ranking a solution, the method comprising:
surveying a user to provide data regarding a particular solution for populating a database having a computer readable medium, the data including responses to a survey;
cross-referencing the responses in order to rank the particular solution, the rank being a numerical value; and
updating the rank of the particular solution such that an overall score for the particular solution includes a weighting algorithm of all rankings.

6. The method of claim 5, wherein the weighting algorithm is one of a diminished type.

7. The method of claim 6, wherein the diminishing weighting algorithm reduces an impact of previous rankings on the overall score.

8. The method of claim 5, further comprising querying the database to produce a representation of the overall score for the particular solution.

9. The method of claim 5, further comprising reviewing a related evaluation regarding the particular solution.

10. The method of claim 5, further comprising requesting a consultation regarding the particular solution.

11. A method of receiving a report, comprising:
operating a processing apparatus in which a user may receive data related to a survey;
building a query of the database using indicated parameters, a response to the query generating a formatted display of information regarding a particular solution;
allowing a user to save the indicated parameters of the query to a memory;
allowing the user to re-execute the saved query; and
electing to receive an alert that indicates changes to the data associated with the query.

12. The method of claim 11, wherein the formatted display includes a chart.

13. The method of claim 11, wherein the changes to the data include updates to the survey data.

14. A method for generating a scorecard, comprising:
establishing key indicators for a particular solution;
submitting responses to a survey to a database based on questions regarding the key indicators, the survey being associated with a user;
assigning a value to each response for each of the questions;
calculating metrics for each value; and
comparing the calculated metrics for the responses to the survey with other calculated metrics for another survey to generate a scorecard for the particular solution.

15. The method of claim 14, wherein the metrics are averages of the values based on a plurality of surveys.

16. The method of claim 14, wherein the metrics are aggregates of the values based on a plurality of surveys.

17. A method of collaboration for members of an industry, comprising:
defining a database of market research data using a Web environment;
obtaining a written analysis for a particular solution from a user having knowledge of a market associated with the particular solution, the analysis for entry in the database;
providing predetermined access privileges to the database for a user that submits a written analysis, the access privilege including viewing the market research data and providing consultation to another user; and
issuing payment to a user that completes a written analysis and provides consultation with another user, the consultation including providing discussion notes to the Web environment.

18. The method of claim 17, further comprising allowing a user that is issued payment to promote services provided by the user.

19. A method of accessing data, comprising:
storing a user survey in a database;
concealing an identity of a user associated with the user survey; and
soliciting payment from another user for viewing the user survey.

20. A collaborative research system, comprising:
an apparatus comprising:
a knowledge base for receiving and delivering data in a computer readable medium;
a user profile having stored information regarding a user, the user profile for granting an access privilege to the knowledge base; and
a survey capable of being run on the computer readable medium, the survey being associated with each user and having a plurality of sections including responses to questions about a particular solution by one or more users,
wherein the responses are for populating the knowledge base with selectively added data received from one or more of the users, and
wherein the user can continuously update a survey associated with the user upon collection of additional data;
a method of collecting data comprising:
surveying a user to provide data regarding a particular solution for populating a database having a computer readable medium, the data including responses to a survey;
cross-referencing the responses in order to rank the particular solution, the rank being a numerical value; and
updating the rank of the particular solution with additional data such that an overall score for the particular solution includes a weighting algorithm of all rankings;
a method of receiving a report comprising:
operating a processing apparatus in which a user may receive data related to a survey;
building a query of the database using indicated parameters, a response to the query generating a formatted display of information regarding a particular solution;
allowing a user to save the indicated parameters of the query to a memory;
allowing the user to re-execute the saved query; and
electing to receive an alert that indicates changes to the data associated with the query;
a method for generating a scorecard comprising:
establishing key indicators for a particular solution;
submitting responses to a survey to a database based on questions regarding the key indicators, the survey being associated with a user;
assigning a value to each response for each of the questions;
calculating metrics for each value; and
comparing the calculated metrics for the responses to the survey with other calculated metrics for another survey to generate a scorecard for the particular solution;
a method of collaboration for members of an industry comprising:
defining a database of market research data using a Web environment;
obtaining a written analysis for a particular solution from a user having knowledge of a market associated with the particular solution, the analysis for entry in the database;
providing predetermined access privileges to the database for a user that submits a written analysis, the access privilege including viewing the market research data and providing consultation to another user; and
issuing payment to a user that completes a written analysis and provides consultation with another user, the consultation including providing discussion notes to the Web environment; and
a method of accessing data comprising:
storing a user survey in a database;
concealing an identity of a user associated with the user survey; and
soliciting payment from another user for viewing the user survey.
